(19) United States
(12) Patent Application Publication
(10) Pub. No.: US 2005/0245331 A1
(43) Pub. Date: Nov. 3, 2005

(54) Method and system of enhancing a game

(76) Inventor: Michael David Renbarger, Granger, IN (US)

Correspondence Address: BARNES & THORNBURG LLP, 600 1st Source Bank Center, 100 North Michigan, South Bend, IN, 46601-1632, US

(21) Appl. No.: 10/837,807

(22) Filed: May 3, 2004

(51) Int. Cl. A63F 9/24; G06F 19/00; A63B 67/00

(52) U.S. Cl. 473/415

(57) ABSTRACT

A method and system of enhancing a sports game. The method comprises the player initiating an operation of the game by activating an input. A receiver relays the input to the processor which compares the input to a database stored in the game. The processor then generates an output in response to the processing of the input. The transmitter sends the output to an output member wherein the output attracts at least one of the senses of a player of the game in order to stimulate the player. The system comprises a housing having an input member and an output member. A receiver positioned within the housing is adapted to receive an input via the input member. A processor positioned within the housing and in communication with the receiver generates an output based on the input. A transmitter positioned within the housing and in communication with the processor sends the output via the output member to attract at least one of the senses of a player in order to stimulate the player such that the player responds to the output.

The present disclosure relates to a method and system for enhancing a sports game. In particular, the present disclosure relates to a method and system which enhances a game by generating outputs which attract the players of the game in order to stimulate the players during the game.

In the field of sports, games such as basketball, hockey or soccer require a variety of moves and techniques which are used by a single player or in tandem with other players. Instructional booklets provide a common method of teaching these moves and techniques by displaying pictures of the play of the game. Coaches provide another common method of teaching the moves and techniques by showing the players the interactions of the game. Thus, the instructional booklet or the coach provides the training techniques of playing the game. In these training techniques, the players try to absorb the instructions of the book/coach and try to replicate the instructions to further advance the moves or techniques of the game. These teaching techniques work only in one dimension for the player, though, since the player must first read the instructions and then try to replicate the instructions later during play of the game. As such, these techniques are not conducive for the players to simultaneously learn and practice the moves and techniques of the game.

When a player practices a game such as basketball, the instructional booklet is not conducive for advancing the player's training and enjoyment of the game. For example, when playing alone the player must read the instructions, move to the playing court, recall the instructions and try to replicate the instructions while performing the moves and techniques of the game. As such, the instructional booklet prohibits a player from learning the moves and techniques during real time practice of the game since the player has to reciprocate back and forth between the instructional booklet and the court while performing during practice sessions. As such, the player loses continuity of the play while practicing the game.

Stimulating the player while practicing the game further advances the training and enjoyment of the game. In a practice session for the game, however, motivating crowds and/or announcers are not present to stimulate the players. Thus, during practice, players miss an important opportunity for stimulation in order to advance their learning and enjoyment of the game.

During practice, the player does not have motivational support from other players, crowds, announcers or coaches which limits the stimulation of the player during the practice session. For example, during an actual game, a crowd cheers a player while the announcer analyzes and reports the action of the game. Additionally, the crowd or announcer typically recites a countdown sequence of the score board during the later portion of a period such as the last ten seconds of a quarter. This countdown sequence enhances the player's energy and alertness to further enhance the final portions of the game. Additionally, the countdown sequence enhances the player's enjoyment of the game due to the heighten activity of the crowd and announcer. As such, when a player or a small number of players practice the game, the players do not experience this heightened activity during the practice session which reduces the energy and enjoyment of the game during the practice session.

Information and enjoyable experiences are crucial for a beneficial practice regimen. As such, players need valuable instructions while simultaneously practicing the moves and techniques of the game. Additionally, players need motivation to stimulate the players during practice sessions in order to advance the enjoyment of the game for the players. Accordingly, a need exists for an information and motivational system which assist players during a practice session of the game.

### SUMMARY

The present disclosure relates to a method and system for enhancing a sports game. In particular, the present disclosure relates to a method and system which enhances a game by generating outputs which attract the players of the game in order to stimulate the players during the game. In an embodiment, the method comprises the player initiating an operation of the game by activating an input. A receiver then relays the input to the processor which compares the input to a database stored in the game. The processor then generates an output in response to the processing of the input. Next, the transmitter sends the output to an output member wherein the output attracts at least one of the senses of a player of the game in order to stimulate the player.

In an embodiment, the present disclosure comprises a system which includes a housing having an input member and an output member. A receiver positioned within the housing is adapted to receive an input via the input member. The system further includes a processor positioned within the housing and in communication with the receiver, wherein the processor generates an output based on the input. A transmitter positioned within the housing and in communication with the processor, sends the output via the output member to attract at least one of the senses of a player in order to stimulate the player such that the player responds to the output.

### BRIEF DESCRIPTION OF THE DRAWINGS

The detailed description particularly refers to the accompanying figures in which:

FIG. 1 is an elevational view of a game system in accordance with an embodiment of the present disclosure;

FIG. 2 is a schematic view illustrating components of the game system of FIG. 1;

FIGS. 3a-3c are elevational views of housing embodiments of the game system of FIG. 2; and

FIG. 4 is a flowchart illustrating steps of a method for enhancing a game in accordance with an embodiment of the present disclosure.

### DETAILED DESCRIPTION

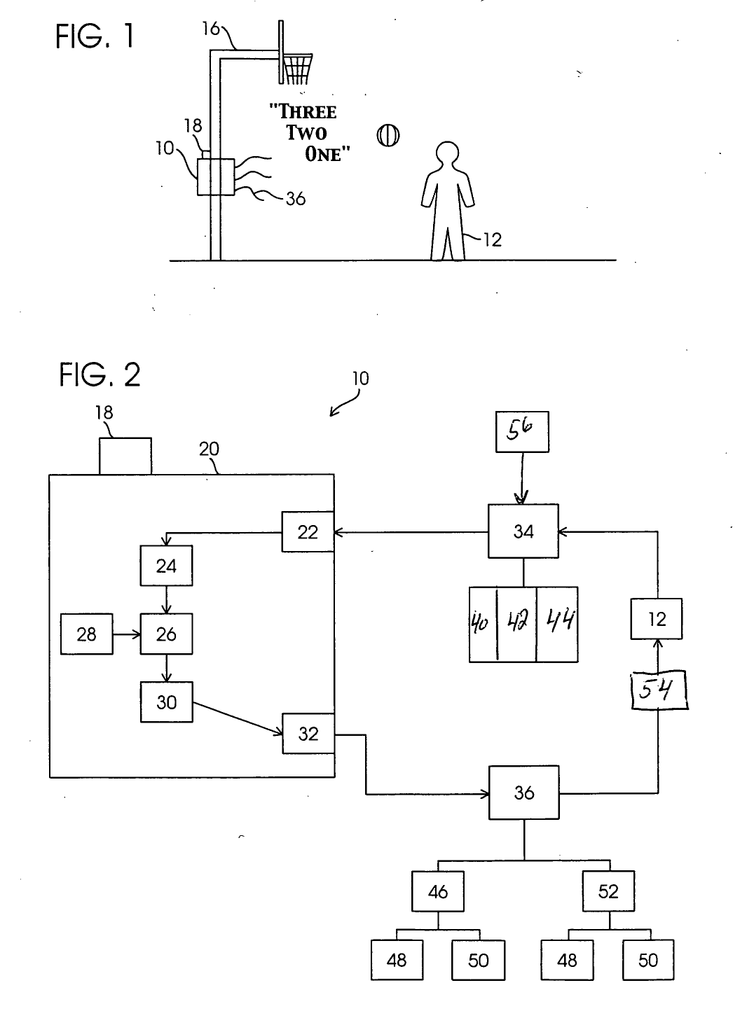

FIG. 1 illustrates in an elevational view an embodiment of the present disclosure generally shown as system 10. The system 10 is used with a player 12 or players 12 playing a game 14, wherein FIG. 1 illustrates the game 14 as basketball. The system 10 may be fixed to a game element 16 such as a pole used during the game 14. Additionally, the system 10 may be removably attached to the element 16 by an attachment 18 such as a handle or straps to provide portability of the system 10. The attachment 18 is configured to attach the system 10 to the game element 16 in any suitable and convenient manner.

Turning to FIG. 2, the system 10 is shown in a schematic view wherein the system 10 comprises a housing 20, the attachment 18, an input member 22, a receiver 24, a processor 26, a database 28, a transmitter 30 and an output member 32. The housing 20 may comprise a weather resistant and durable material to withstand exposure to the elements and to withstand impact from elements of the game 14 such as contact by balls or players 12. Additionally, the housing 20 is sized and shaped for portability in order to efficiently and conveniently connect to the game element 16 (FIG. 1) by the attachment 18.

The input member 22 comprises a device for the player 12 to initiate operation of the system 10. The input member 22 may comprise an electromechanical device such as a keypad. The input member 22 may also comprise a sensor such as an optical sensor, a voice recognition sensor or an infrared sensor. The output member 32 comprises another device for the system 10 to attract the player 12. The output member 32 may comprise an electromechanical device such as a speaker. The output member 32 may also comprise an illumination device such as lights. The output member 32 may also comprise a display such as a video screen.

The receiver 24, processor 26 and transmitter 30 are components positioned within the housing 20 wherein the receiver 24 communicates an input 34 from the input member 22 to the processor 26. The transmitter 30 communicates an output 36 from the processor 26 to the output member 32, as will be discussed. The receiver 24 is configured to relay the input 34 to the processor 26 which compares the input 34 with the database 28. The processor 26 generates the output 36 based on the processed input 34. The transmitter 30 is configured to relay the output 36 to the output member 32 to attract the player 12. The database 28 may include pre-programmed information 38 as will be discussed.

As shown in FIG. 2, the player 12 activates the input 34 while playing the game 12. The input 34 may include engaging the input member 22 such as pressing the keypad. The input 34 may also include sending an optical signal 40 such as a movement by the player 12 during the game 12. The input 34 may also include sending an infrared signal 42 such as a remote control command. Furthermore, the input 34 may comprise sending a voice recognition signal 16 such as a voice command from the player 12.

The output 36, meanwhile, is configured to alert the player 12 by attracting at least one of the senses 54 of the player 12. As such, the output 36 may comprise an audio signal 46. In an embodiment, the audio signal 46 may comprise reciting instructions 48 relating to the game 14. In another embodiment, the audio signal 46 may comprise reciting a countdown sequence 50 relating to the game 14. The output 36 may also comprise a visual signal 52. In an embodiment, the visual signal 52 may comprise displaying the instructions 48 relating to the game. In another embodiment, the visual signal 52 may comprise displaying the countdown sequence 50 relating to the game 14. The visual signal 52 may also comprise illumination of lights.

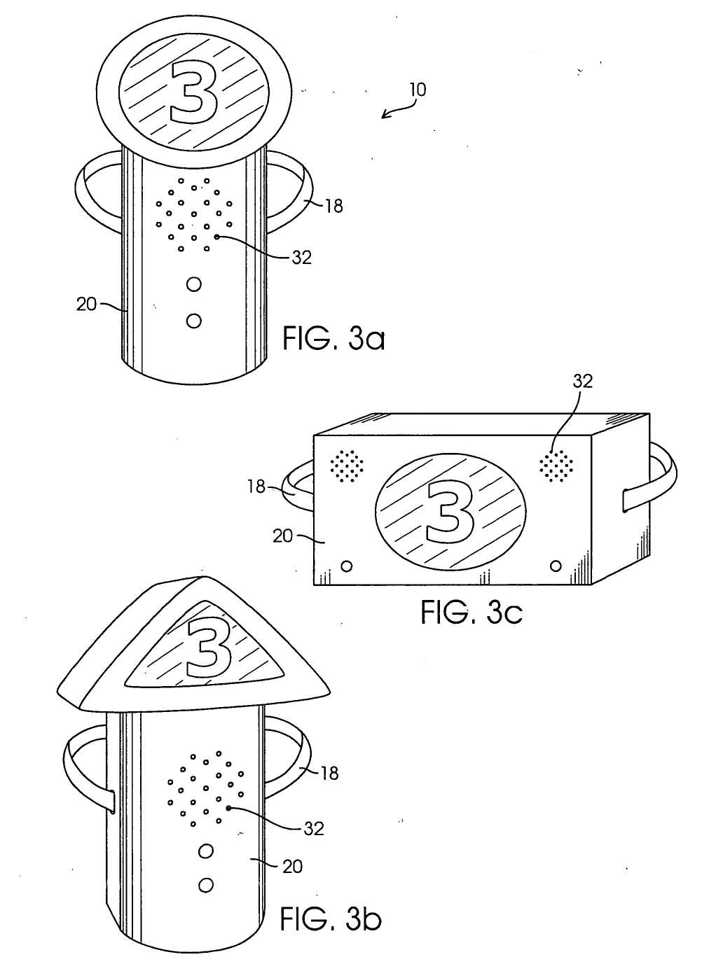

Turning to FIGS. 3a-3c, the system 10 is shown having a plurality of housings 20. The housings 20 may represent components of the game 14 such as a scoreboard, direction arrow or basket. Regardless of the configuration of the housing 20, the housing 20 may be removably connected to the game element 16 (FIG. 1) by the attachment 18. As shown in FIGS. 3a-3c, the output member 32 is illustrated as a speaker.

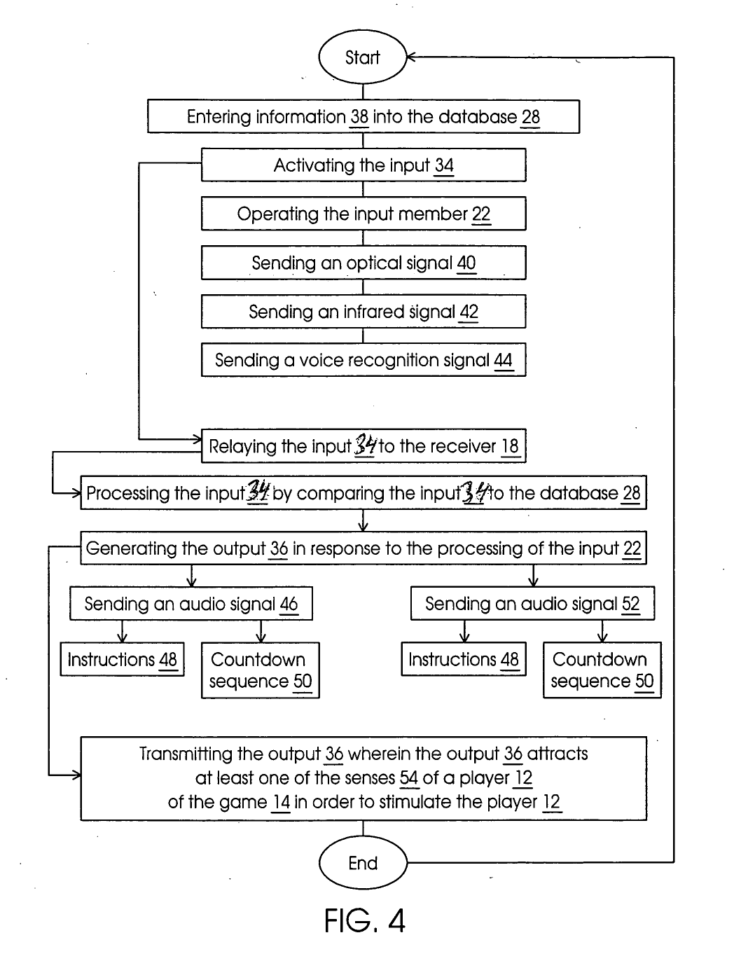

Turning to FIGS. 1, 2 and 4, the system 10 attracts at least one of the senses 54, such as sight, or hearing of the player 12 to stimulate the player 12 while engaged with the game 14. During use, the player 12 may input information 38 into the database 28 wherein the information 38 relates to the output 36 desired by the player 12. As such, the information 38 may relate to the instructions 48 of the game 14. For example, the instructions 48 may state the procedure for certain techniques of the game 12 such as but not limited to: a cross over dribble, a lay-up or jump shot for basketball; a penalty kick set up, a scissor kick or bender kick for soccer; or a wrist shot or a check for hockey.

To input the information 38, a player 12 may voice record the information 38 via the processor 26. Thus, the player 12 may record the information 38 such as instructions 48 of the game 14 as the voice of the player 12. In another embodiment, the player may download the instructions 48 into the processor 26 of the system 10. Still further, the player 20 may video record himself/herself performing moves and techniques of the game 14 and download the video recording into the processor 26. As such, in these embodiments, the player 12 personally creates the instructions 48 to match the individual preferences of the player 12 on explaining and/or showing the instructions 48 of the game 14.

In another embodiment, the instructions 48 of the game 14 may be preprogrammed into the database 28 of the processor 26 by the manufacturer. In this embodiment, the manufacturer may voice record the instructions 48 of the game 14 into the processor 26. Additionally, the manufacturer may download the instructions 48 of the game 14 into the processor 26. Still further, the manufacturer may input video showing the instructions 48 of the game 14 into the processor 26. In these embodiments, the manufacturer may create the database 28 having all the instructions 48 of the game 14.

Regardless of whether the player 12 or manufacturer inputs the instructions 48 into the database 28 of the processor 26, the instructions 48 are stored to provide the player 12 access to the instructions 48 via the system 10. Additionally, the instructions 48 stored in the database 28 are not limited to any particular game 14. Further, the database 28 and processor 26 are configured to hold instructions 48 for a plurality of games in a plurality of forms such as voice recordings, text and/or video.

To input information 38 into the database 28 in another embodiment, the player 12 may also voice record the information 38 such as the countdown sequence 50 of the game 14. In another embodiment, the player may download the countdown sequence 50 into the processor 26 of the system 10. Still further, the player 20 may video record the countdown sequence 50 and download the countdown sequence 50 into the processor 26. As such, in these embodiments, the player 12 creates the countdown sequence 50 to match the individual preferences of the player 12 illustrating the countdown sequence 50.

In another embodiment, the countdown sequence 50 of the game 14 may be preprogrammed into the database 28 of the processor 26 by the manufacturer. In this embodiment, the manufacturer may voice record the countdown sequence 50 of the game 14 into the processor 26. Additionally, the manufacturer may download the countdown sequence 50 of the game 14 into the processor 26. Still further, the manufacturer may download video showing the countdown sequence 50 of the game 14 into the processor 26.

Regardless on whether the player 12 or manufacturer inputs the countdown sequence 50 into the database 28 of the processor 26, the countdown sequence 50 is stored to provide the player 12 access to the countdown sequence 50 via the system 10. Table 1 illustrates examples of the countdown sequence 50.

10, 9, 8, 7, 6, 5, 4, 3, 2, 1!
5, 4, 3, 2, 1!
3, 2, 1!
He Shouts, He Scores!
Up for the Shot and Is Fouled!

After inputting the information 38 into the database 28, the player 12 activates the input 34 in order to initiate operation of the game 14. The input 34 may comprise an action such as the player 12 manually operating the input member 22 such as the keypad. The input member 22 then signals actuation of the system 10 according to commands entered into the keypad. The input 18 may also comprises an optical signal 40 such as the player 12 making a movement wherein the movement activates an optical sensor on the input member 22. The input 34 may also comprise a voice recognition signal 44 such as the player 12 stating a voice command wherein a voice recognition sensor on the input member 22 starts activation of the system 10. The input 34 may also comprise an infrared signal 42 sent by a remote input device 56 wherein an infrared sensor on the input member 22 starts actuation of the system 10.

The receiver 24 then receives the input 34 from the input member 22 wherein the receiver 24 relays the input 34 to the processor 26. The processor 26 then compares the input 34 with the information 38 stored in the database 28. The processor 26 then generates the output 36 wherein the transmitter 30 relays the output 36 to the output member 32. The output 36, in turn, attracts at least one of the senses 54 of the player 12 to stimulate the player 12.

The output member 32 is configured to transmit the output 36 as the audio signal 46 to attract the hearing of the player 12. The output member 32 is also configured to transmit the output 36 as the visual signal 52 to attract the sight of the player 12. The output member 32 is also configured to transmit the output 36 as a combination of the audio signal 46 and the visual signal 52. In an embodiment, the audio signal 46 may comprise instructions 48 for the game 14. In another embodiment the audio signal may comprise the countdown sequence 50 of the game 14. Still further, in an embodiment, the visual signal 52 may comprise instructions 48 of the game 14. Additionally, in another embodiment, the visual signal 52 may comprise the countdown sequence 50 of the game 14.

In an embodiment, the audio signal 46 representing the instructions 48 of the game 14 recites the instructions 48 to the player 12 while the player 12 simultaneously plays the game 14. Additionally, the audio signal 46 representing the countdown sequence 50 of the game 14 recites the desired countdown sequence 50 to the player 12 while the player 12 simultaneously plays the game 14. In an embodiment, the visual signal 52 representing the instructions 48 of the game 14 displays the instructions 48 to the player 12 while the player 12 simultaneously plays the game 14. Additionally, the visual signal 52 representing the countdown sequence 50 of the game 14 displays the desired countdown sequence 50 to the player 12 while the player 12 simultaneously plays the game 14. Depending on the information 38 within the database 28, the visual signal 52 may display the information 38 as text or video.

In an example, information 38 such as the instructions 48 of a cross over dribble for a basketball game are inputted into the database 28 of the processor 26 by either the player 12 or manufacturer. The instructions 48 of a cross over dribble may be inputted into the database 28 by inputting video of performing a cross over dribble. Additionally, the instructions 48 of the cross over dribble may be inputted into the database 28 by reciting steps of the cross over dribble. Next, the player 12 may activate the input 34 by the voice recognition signal 44 by stating a voice command such as: “cross over dribble”.

The input member 22 then communicates the input 60 to the receiver 24. The receiver 24, in turn, relays the input 34 to the processor 26. The processor 26 then processes the input 34 by comparing the input 34 to the database 28 having the information 38. The processor 26 will then processes the input 34 (“cross over dribble”) and compare that with the information 38 relating to the game 14. The processor 26 will then generate the output 36 wherein the transmitter 30 relays the output 36 to the output member 32. The output member 32 then sends the output 36 as the audio signal 46 to attract the senses 54 of the player 12 where the audio signal 46 states the instructions 48 on performing a cross over dribble. The output member 32 may also send the output 36 as the visual signal 52 wherein the visual signal 52 displays video footage of a cross over dribble.

in another example, the countdown sequence 50 such as “Three, two, one,” for a basketball game is inputted into the processor 26 by either the player 12 or manufacturer. The countdown sequence 50 may be inputted by voice recording the countdown sequence 50 as previously described. The countdown sequence 50 may also be inputted by downloading video of the countdown sequence 50. Next, the player 12 activates the input 34 such as sending the infrared signal 42 by the remote control device 56 to the input member 22.

The input member 22 then communicates the input 34 to the receiver 24. The receiver 24, in turn, relays the input 34 to the processor 26, The processor then processes the input 34 by comparing the input 34 to the database 28. The processor 26 will then generate the output 36 wherein the transmitter 14 relays the output 36 to the output member 32. The output member 32 then sends the output 36 as the audio signal 46 where the audio signal 46 recites the countdown sequence 50. The output member 32 may also send the output 36 as the visual signal 52 wherein the visual signal 49 displays video footage of the countdown sequence 50. As such, the output 50 attracts at least one of the senses 54 of the player 12 to stimulate the player 12.

While the present disclosure describes players, games, audio and video, it is understood that the present disclosure is not limited to a set number of players or games described or the audio and video examples described in the disclosure. Additionally, while the concepts of the present disclosure have been illustrated and described in detail in the drawings and foregoing description, such an illustration and description is to be considered as exemplary and not restrictive in character, it being understood that only the illustrative embodiments have been shown and described and that all changes and modifications that come within the spirit of the disclosure are desired to be protected by the following claims.

1. A method of enhancing a game, comprising:
initiating an operation of the game by activating an input;
relaying the input to a receiver;
processing the input by comparing the input to a database stored in the game;
generating an output in response to the processing of the input;
transmitting the output wherein the output attracts at least one of the senses of a player of the game in order to stimulate the player.

2. The method of enhancing a game according to claim 1, further comprising entering information into the database.

3. The method of enhancing a game according to claim 1, wherein activating the input comprises manually operating an input member.

4. The method of enhancing a game according to claim 1, wherein activating the input comprises sending an optical signal.

5. The method of enhancing a game according to claim 1, wherein activating the input comprises sending an infrared signal.

6. The method of enhancing a game according to claim 1, wherein activating the input comprises sending a voice recognition signal.

7. The method of enhancing a game according to claim 1, wherein transmitting the output comprises sending an audio signal.

8. The method of enhancing a game according to claim 7, wherein the audio signal comprises instructions for the game.

9. The method of enhancing a game according to claim 7, wherein the audio signal comprises a countdown sequence of the game.

10. The method of enhancing a game according to claim 1, wherein transmitting the output comprises sending a visual signal.

11. The method of enhancing a game according to claim 10, wherein the visual signal comprises instructions for the game.

12. The method of enhancing a game according to claim 10, wherein the visual signal comprises a countdown sequence of the game.

13. A method of enhancing a game by stimulating a player, comprising:
initiating an operation of the game by entering information into a database stored in the game;
relaying an input to a receiver;
processing the input by comparing the input to the database;
generating an output in response to the processing of the input;
transmitting the output wherein the output attracts at least one of the senses of a player of the game such that the player responds to the output.

14. The method of enhancing a game according to claim 13, wherein entering information comprises entering instructions for the game.

15. The method of enhancing a game according to claim 13, wherein entering information comprises entering a countdown sequence of the game.

16. The method of enhancing a game according to claim 13, wherein transmitting the output comprises sending an audio signal.

17. The method of enhancing a game according to claim 1, wherein transmitting the output comprises sending a visual signal.

18. A system for enhancing a game, comprising:
a housing having an input member and an output member;
a receiver positioned within the housing, the receiver being adapted to receive an input;
a processor positioned within the housing and in communication with the receiver, the processor being adapted to generate an output based on the input; and
a transmitter positioned within the housing and in communication with the processor wherein the transmitter is adapted to send the output to attract at least one of the senses of a player in order to stimulate the player such that the player responds to the output.

19. The system for enhancing a game according to claim 18, wherein the input comprises an optical signal.

20. The method of enhancing a game according to claim 18, wherein the input comprises a voice recognition signal.

21. The method for enhancing a game according to claim 18, wherein the output comprises an audio signal.

22. The method for enhancing a game according to claim 21, wherein the audio signal comprises instructions for the game.

23. The method for enhancing a game according to claim 21, wherein the audio signal comprises a countdown sequence of the game.

24. The method for enhancing a game according to claim 18, wherein the output comprises a visual signal.

25. The method of enhancing a game according to claim 24, wherein the visual signal comprises instructions for the game.

26. The method of enhancing a game according to claim 24, wherein the visual signal comprises a countdown sequence of the game.
